(19) United States
(12) Patent Application Publication
(10) Pub. No.: US 2014/0238998 A1
(43) Pub. Date: Aug. 28, 2014

(54) Shaped Cooking Vessel

(71) Applicant: George H. SCHWING, III, Covington, LA (US)

(72) Inventor: George H. SCHWING, III, Covington, LA (US)

(21) Appl. No.: 14/179,354

(22) Filed: Feb. 12, 2014

Related U.S. Application Data
(60) Provisional application No. 61/769,428, filed on Feb. 26, 2013.

(51) Int. Cl. A47J 27/00; A47J 36/02

(52) U.S. Cl. CPC A47J 27/002; A47J 36/025
USPC 220/573.2; 220/573.1

(57) ABSTRACT

A shaped cooking vessel for preparing food; particularly oysters. The shaped cooking vessel is formed from a planar base and a lateral wall of uniform thickness; the planar base and the lateral wall preferably being in the general shape of an oyster shell. The planar base provides a flat surface for evenly heating food and for balancing the shaped cooking vessel as to prevent rolling. The lateral wall provides a sufficient depth as to retain both solid and liquid food stuffs. A plurality of ridges integrated into the lateral wall provides an increased surface area in order to increase the heat transfer from the lateral wall to the food to be prepared, which in turn decreases cooking time of said food.

The shaped cooking vessel can be nestled between a preceding cooking vessel and a subsequent cooking vessel in order to reduce storage space.

The current application claims a priority to the U.S. Provisional Patent application Ser. No. 61/769,428 filed on Feb. 26, 2013.

### FIELD OF THE INVENTION

The present invention relates generally to cooking vessels. More specifically, the present invention is a reusable cooking vessel that provides shorter cooking times as compared to natural cooking vessels. Furthermore, the present invention has a sufficient depth for the holding and containing of food products, sauces, juices, etc. within the vessel.

### BACKGROUND OF THE INVENTION

Oysters are common seafood and are routinely fished, harvested, and farmed for culinary purposes. Oysters are a popular delicacy favored for their taste as well as their nutritional benefits, and may be consumed raw or cooked based on the preference of the consumer. For safe consumption, oysters are eaten alive or cooked when alive before being eaten. In order to preserve flavor, by far the most popular method of consuming oysters is raw and on the half shell with light seasoning or sauce. However, those who enjoy cooked oysters are provided a myriad of cooking recipes and options. Preparation of cooked oysters is versatile, as oysters may be baked, boiled, broiled, fried, grilled, roasted, and smoked, amongst other cooking methods. A common method of cooking oysters involves placing oysters on the half shell on a cooking surface such as a grill. The oysters are then lightly cooked in their natural juices and/or any desired seasonings.

There are several problems encountered when cooking oysters on the half shell on flat surfaces such as flattop grills. Due to the uneven exterior surfaces of oyster shells, it is common for oysters to roll on the flat surface during cooking. This is problematic as juices contained within the oyster shell are essential to maintaining proper flavor and these juices are lost when the shells roll. Additionally, oyster shell thickness is not consistent along all portions of the shell. The uneven thickness in turn leads to uneven cooking of the oyster meat within the shell, with the potential for burning some or all of the oyster meat. Furthermore, if bacteria is present on natural oyster shells, the bacteria may be transferred to the consumer through handling the shell, especially if the oysters are served raw. The present invention seeks to address the aforementioned issues encountered when cooking oysters on the half shell on a flat surface.

The present invention is a shaped cooking vessel primarily intended for use when cooking oysters on flat surfaces. In the preferred embodiment of the present invention, a planar base and a lateral wall form an approximately shell shaped, stainless steel vessel. The planar base provides a flat surface and prevents movement of the shaped cooking vessel and the contents within the shaped cooking vessel during the cooking process. The lateral wall encompasses the planar base and is angled in an upward direction away from the planar base. In conjunction with the planar base, the tapered wall of the shaped cooking vessel provides a non-permeable containment for any solids or fluids within the cooking vessel. This is essential as natural oyster juices and seasonings are essential to maintaining a high level of flavor. The planar base and lateral wall of the shaped cooking vessel are of a uniform thickness in order to provide consistent cooking throughout the vessel through the even distribution of heat about the shaped cooking vessel. The stainless steel composition of the shaped cooking vessel considerably shortens oyster cooking times compared to natural shells as well. Additionally, stainless steel is not known to leech chemicals or toxins when heated, as compared to other materials. The cooking process is relatively straightforward, as oyster meat is simply removed from the natural shell and placed into the cooking vessel along with the natural juices and seasonings. The shaped cooking vessel is then placed on a cooking surface such as a grill. Alternatively, oyster meat may be purchased already removed (shucked) from its natural shell from a local grocery store or a seafood purveyor. As a result, a user is not required to clean the oyster shell.

The present invention is versatile, as the cooking vessel is not limited solely to cooking oysters. Foods such as clams, mussels, chicken, shrimp, other meats, and vegetables may be cooked utilizing the present invention, amongst others. The present invention is sanitary, hand washable after every use, and reusable as with conventional cookware.

### BRIEF DESCRIPTION OF THE DRAWINGS

FIG. 1 is a perspective view of the present invention.

FIG. 2 is a top plan view of the present invention.

FIG. 3 is a bottom plan view of the present invention.

FIG. 4 is a front sectional view of the present invention.

FIG. 5 is a perspective view of the shaped cooking vessel aligned with a preceding cooking vessel and a subsequent vessel.

FIG. 6 is a perspective view of the present invention nestled between the preceding cooking vessel and the subsequent cooking vessel.

FIG. 7 is a perspective view of multiples of the present invention positioned across a flattop grill.

### DETAIL DESCRIPTIONS OF THE INVENTION

All illustrations of the drawings are for the purpose of describing selected versions of the present invention and are not intended to limit the scope of the present invention.

The present invention is a shaped cooking vessel for grilling, baking, cooking, or otherwise preparing food. In the preferred embodiment of the present invention, the shaped cooking vessel is designed and contoured for preparing oysters, however, it is possible for the shaped cooking vessel to be designed and contoured for preparing any other kind of food. While oysters are the preferred food to be prepared using the present invention, it is possible for any other food stuffs to be prepared using the present invention.

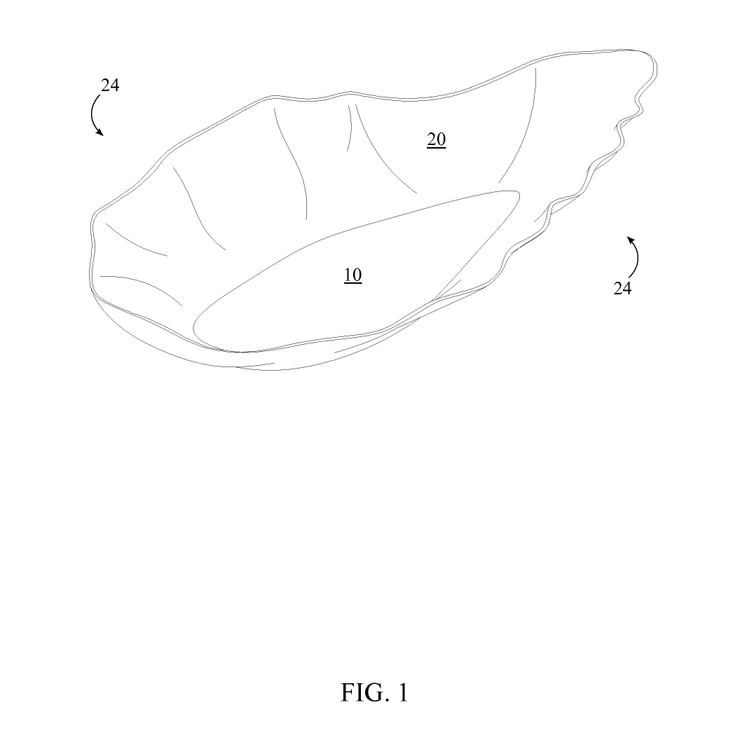

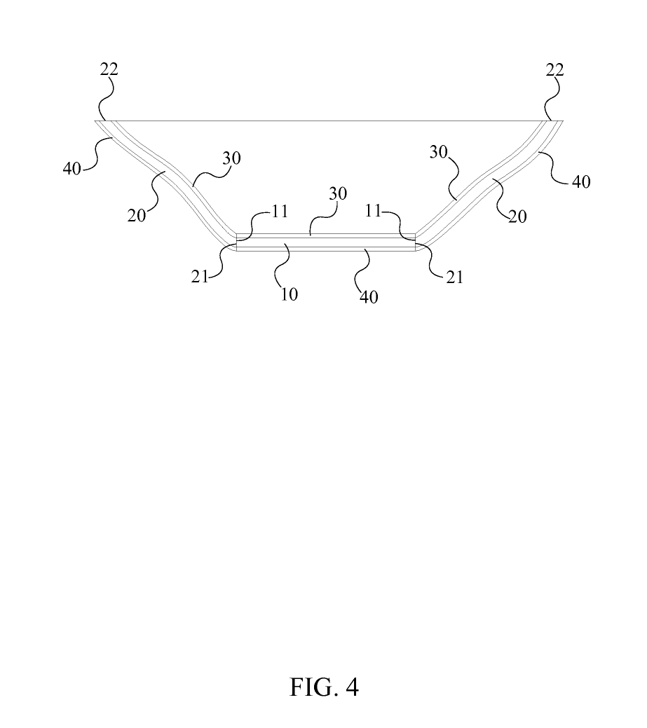

In reference to FIG. 1 and FIG. 4, the shaped cooking vessel comprises a planar base 10, a lateral wall 20, an inner surface 30, an outer surface 40, and a plurality of ridges 24. The planar base 10 provides a flat bottom surface for the present invention. In this way, the shaped cooking vessel rests flat on a given surface and the food to be prepared is evenly heated within the shaped cooking vessel. The lateral wall 20 is positioned around the planar base 10 and provides the shaped cooking vessel with a depth sufficient for containing the desired food to be prepared. The inner surface 30 is positioned about both the planar base 10 and the lateral wall 20. Similarly, the outer surface 40 is positioned about both the planar base 10 and the lateral wall 20, opposite the inner surface 30. The inner surface 30 may be designed with non-stick properties and thus the inner surface 30 may be polytetrafluoroethylene or a similar material.

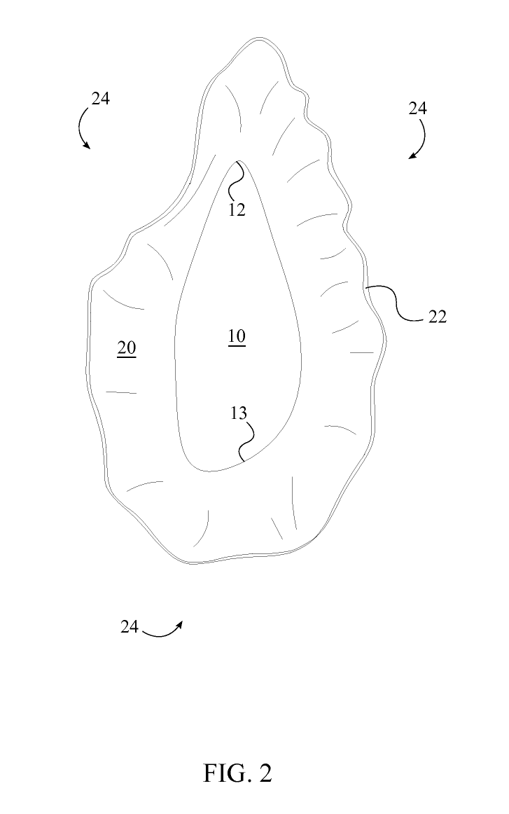

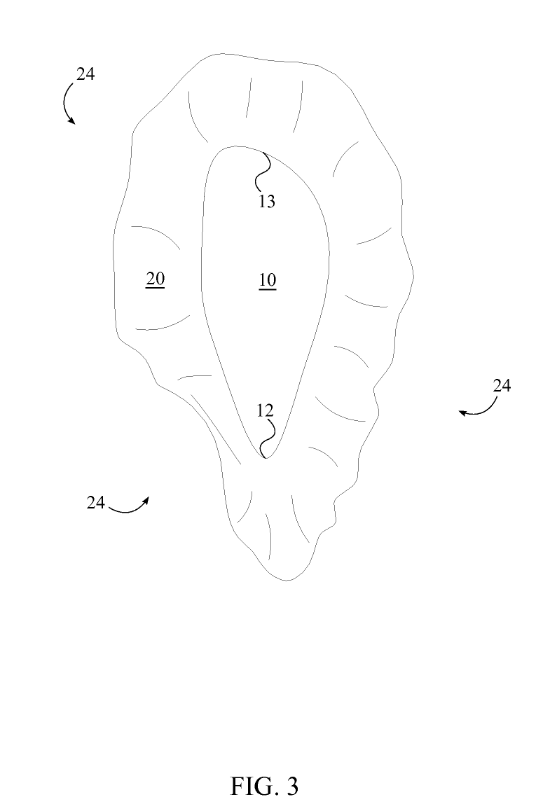

In the preferred embodiment of the present invention, the lateral edge 11 of the planar base 10 comprises a small curve 12 and a large curve 13, as shown in FIG. 2-3. The small curve 12 and the large curve 13 are positioned opposite each other along the planar base 10. Both the radius and the length of the large curve 13 are greater than the radius and the length of the small curve 12, respectively. In addition to defining the cross sectional area of the planar base 10, the small curve 12 and the large curve 13 define the shape and curvature of the lateral wall 20, leading to an overall oyster-like shape.

In reference to FIG. 4, the planar base 10 comprises a lateral edge 11, while the lateral wall 20 comprises a proximal edge 21 and a distal edge 22. The proximal edge 21 is perimetrically positioned around the lateral wall 20; forming the bottom edge of the lateral wall 20. Similarly, the distal edge 22 is perimetrically positioned around the lateral wall 20, opposite the proximal edge 21; forming the top edge of the lateral wall 20. The proximal edge 21 is perimetrically connected to the lateral edge 11 of the planar base 10, thus connecting the lateral wall 20 to the planar base 10.

In the preferred embodiment of the present invention, the lateral wall 20 is tapered from the distal edge 22 to the proximal edge 21, as shown in FIG. 4. In this way, the inner surface 30 is concavely positioned about the planar base 10 and the lateral wall 20, while the outer surface 40 is convexly positioned about the planar base 10 and the lateral wall 20. The lateral wall 20 being tapered further bolsters the overall oyster-like appearance of the shaped cooking vessel, in addition to the curved nature of the planar base 10 in the preferred embodiment of the present invention.

In reference to FIG. 1, the plurality of ridges 24 is integrated into the lateral wall 20, giving the lateral wall 20 a wave-like appearance, similar to that of natural oyster shells. The plurality of ridges 24 is interspersed around the lateral wall 20, with each of the plurality of ridges 24 being positioned from the distal edge 22 to the proximal edge 21. The plurality of ridges 24 increases the surface area of the lateral wall 20, and thus provides increased heat transfer to the food being cooked within the shaped cooking vessel. The increased heat transfer in turn decreases the cooking time of said food. Additionally, the plurality of ridges 24 provides increased structural stability of the lateral wall 20, preventing the lateral wall 20 from readily being deformed from the intended curvature, as compared to if the lateral wall 20 were smooth.

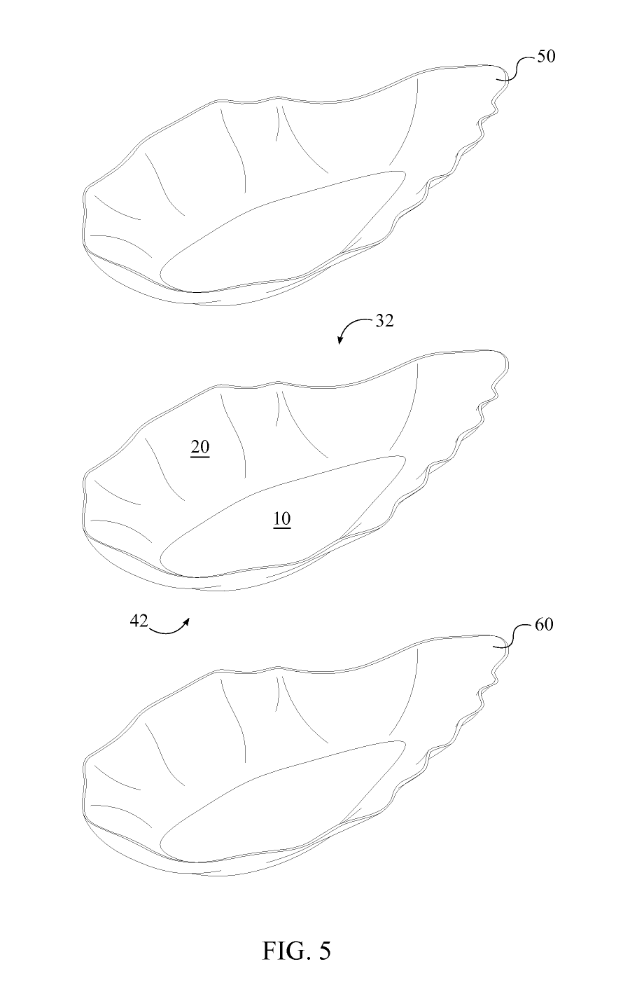

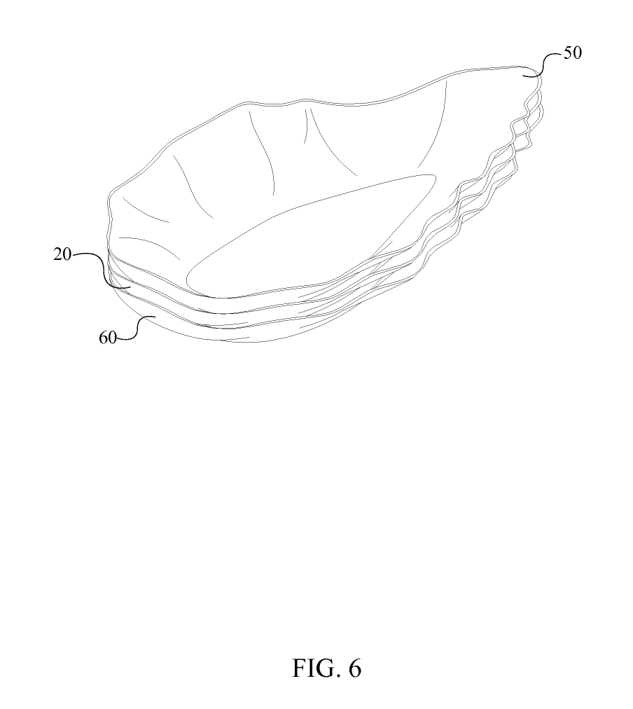

In reference to FIG. 5-6, the outer surface 40 defines a cooking vessel insertion contour 42 for a preceding cooking vessel 60. Similarly, the inner surface 30 defines a cooking vessel receiving contour 32 for a subsequent cooking vessel 50. Both the preceding cooking vessel 60 and the subsequent cooking vessel 50 are identical to the shaped cooking vessel. In this way, the present invention is designed such that the shaped cooking vessel can be nestled in between the preceding cooking vessel 60 and the subsequent cooking vessel 50. The cooking vessel insertion contour 42 is positioned into the preceding cooking vessel 60, wherein the outer surface 40 is in contact with a top surface of the preceding cooking vessel 60. Meanwhile, the subsequent cooking vessel 50 is positioned into the cooking vessel receiving contour 32, wherein the inner surface 30 is in contact with a bottom surface of the subsequent cooking vessel 50. The stackability of the shaped cooking vessel acts to reduce the storage space required for cumulating multiples of the present invention.

In the preferred embodiment of the present invention, the planar base 10 and the lateral wall 20 are constructed from stainless steel, however, it is possible for the planar base 10 and the lateral wall 20 to be constructed from other heat transferring materials. Stainless steel is preferred in the construction of the planar base 10 and the lateral wall 20 as stainless steel is sanitary, food safe, leaves no metallic taste, and can be cleaned using readily available cleaning products. Other materials, such as aluminum, will pit, discolor, and warp after multiple uses and cleanings.

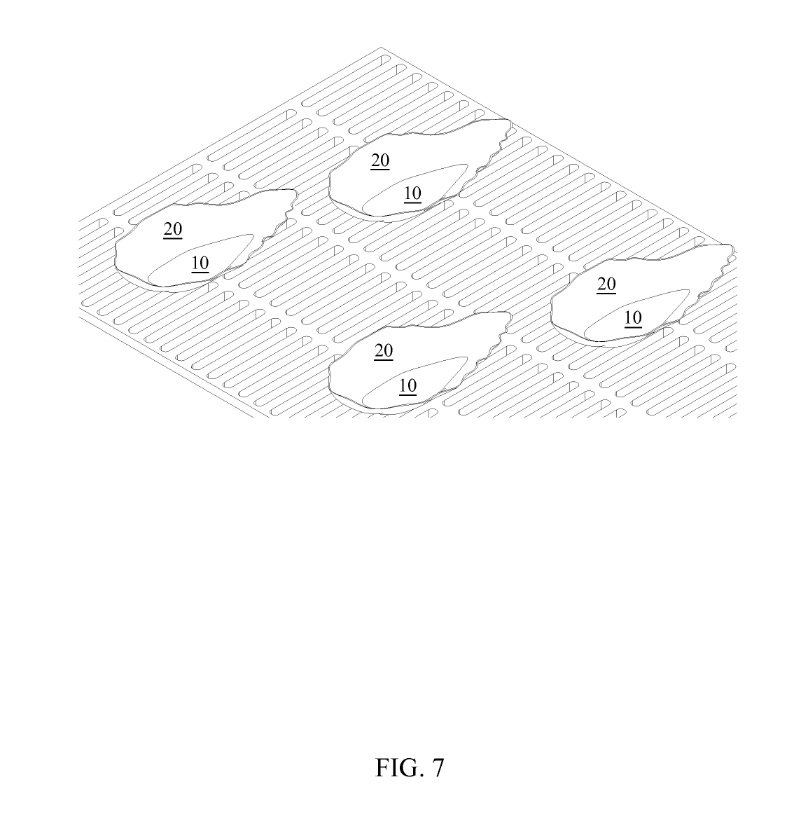

The present invention provides users with a more versatile, efficient, and effective alternative to cooking oysters in their natural half shells. One of the most common methods of cooking oysters involves placing the oysters on the half shell on a generally flat cooking surface, such as a grill, with the natural oyster juice left within the oyster shell. The cook often adds additional seasonings to the oyster meat as well. The oysters are then lightly cooked on the cooking surface. The shaped cooking vessel is used in a similar manner during the cooking process. Oyster meat is removed from the natural shell or purchased in an opened raw state and placed into the shaped cooking vessel along with the natural oyster juice and seasonings. The shaped cooking vessel is then placed on a flat surface in order to cook the contents within, as shown in FIG. 7. Natural oyster juice and additional seasonings are essential to maintaining a desirable flavor of the oysters.

Natural oyster shells feature uneven exterior surfaces, making the oyster meat difficult to cook as the natural oyster shells easily roll on a flat surface. Thus the natural juices within the natural oyster shell are often lost as a result of the oyster shells rolling on the cooking surface. Additionally, the tendency of the natural oyster shells to roll imposes difficulty when attempting to evenly cook the oyster meat within the natural oyster shells. While natural oyster shells have a tendency to roll, the present invention is able to stably rest on a surface due to the planar base 10. The planar base 10 of the present invention provides a flat, stable surface in order to prevent rolling movement of the shaped cooking vessel. Furthermore, the lateral wall 20 of the shaped cooking vessel provides a sufficient depth as to retain any solids or liquids within the cooking vessel.

An additional problem encountered when cooking with natural oyster shells is the uneven thickness of the natural oyster shells. It is quite common for certain portions of the natural oyster shells to be thicker than other portions. This is problematic as cooking the oyster meat within leads to uneven cooking or burning of the oyster meat within the natural oyster shells. As such, the planar base 10 and the lateral wall 20 of the shaped cooking vessel have a uniform thickness, such that heat is evenly distributed about the shaped cooking vessel. Thus the uniform thickness of material ensures even cooking of all contents of the shaped cooking vessel. In addition to remedying the various problems encountered while cooking oysters on the half shell, the shaped cooking vessel provides users with much shorter cooking times when compared to cooking oysters in their natural oyster shells.

The present invention is versatile as the cooking vessel may be used during the cooking process of clams, mussels, chicken, shrimp, meats, and vegetables, amongst other foods. Furthermore, use of the present invention is not limited solely to grilling surfaces. The present invention increases user convenience during the cooking process as well. Oyster meat and natural oyster juices are simply removed from the natural oyster shell or purchased shucked from a local grocer or seafood purveyor and placed into the cooking vessel prior to cooking. Additionally, the present invention is reusable, sanitary, and hand washable after every use. This eliminates the time-consuming washing and cleaning process that accompanies natural oyster shells.

Although the invention has been explained in relation to its preferred embodiment, it is to be understood that many other possible modifications and variations can be made without departing from the spirit and scope of the invention as hereinafter claimed.

What is claimed is:

1. A shaped cooking vessel comprises:
a planar base;
a lateral wall;
an inner surface;
an outer surface;
the planar base comprises a lateral edge;
the lateral wall comprises a proximal edge and a distal edge;
the lateral wall being positioned around the planar base;
the proximal edge being perimetrically positioned around the lateral wall;
the distal edge being perimetrically positioned around the lateral wall opposite the proximal edge;
the proximal edge being perimetrically connected to the lateral edge;
the inner surface being positioned about both the planar base and the lateral wall; and
the outer surface being positioned about both the planar base and the lateral wall opposite the inner surface.

2. The shaped cooking vessel as claimed in claim 1 comprises:
the lateral wall being tapered from the distal edge to the proximal edge;
the inner surface being concavely positioned about the planar base and the lateral wall; and
the outer surface being convexly positioned about the planar base and the lateral wall.

3. The shaped cooking vessel as claimed in claim 1 comprises:
a plurality of ridges;
the plurality of ridges being integrated into the lateral wall;
each of the plurality of ridges being positioned from the distal edge to the proximal edge; and
the plurality of ridges being interspersed around the lateral wall.

4. The shaped cooking vessel as claimed in claim 1 comprises:
the lateral edge comprises a small curve and a large curve; and
the small curve and the large curve being positioned opposite each other along the planar base.

5. The shaped cooking vessel as claimed in claim 1 comprises:
the inner surface defining a cooking vessel receiving contour for a subsequent cooking vessel.

6. The shaped cooking vessel as claimed in claim 1 comprises:
the outer surface defining a cooking vessel insertion contour for a preceding cooking vessel.

7. The shaped cooking vessel as claimed in claim 1 comprises:
the inner surface being polytetrafluoroethylene.

8. The shaped cooking vessel as claimed in claim 1 comprises:
the planar base and the lateral wall being stainless steel.

9. A shaped cooking vessel comprises:
a planar base;
a lateral wall;
an inner surface;
an outer surface;
a plurality of ridges;
the planar base comprises a lateral edge;
the lateral wall comprises a proximal edge and a distal edge;
the lateral wall being positioned around the planar base;
the proximal edge being perimetrically positioned around the lateral wall;
the distal edge being perimetrically positioned around the lateral wall opposite the proximal edge;
the proximal edge being perimetrically connected to the lateral edge;
the inner surface being positioned about both the planar base and the lateral wall;
the outer surface being positioned about both the planar base and the lateral wall opposite the inner surface;
the plurality of ridges being integrated into the lateral wall;
each of the plurality of ridges being positioned from the distal edge to the proximal edge; and
the plurality of ridges being interspersed around the lateral wall.

10. The shaped cooking vessel as claimed in claim 9 comprises:
the lateral wall being tapered from the distal edge to the proximal edge;
the inner surface being concavely positioned about the planar base and the lateral wall; and
the outer surface being convexly positioned about the planar base and the lateral wall.

11. The shaped cooking vessel as claimed in claim 9 comprises:
the lateral edge comprises a small curve and a large curve; and
the small curve and the large curve being positioned opposite each other along the planar base.

12. The shaped cooking vessel as claimed in claim 9 comprises:
the inner surface defining a cooking vessel receiving contour for a subsequent cooking vessel.

13. The shaped cooking vessel as claimed in claim 9 comprises:
the outer surface defining a cooking vessel insertion contour for a preceding cooking vessel.

14. The shaped cooking vessel as claimed in claim 9 comprises:
the inner surface being polytetrafluoroethylene.

15. The shaped cooking vessel as claimed in claim 9 comprises:
the planar base and the lateral wall being stainless steel.

16. A shaped cooking vessel comprises:
a planar base;
a lateral wall;
an inner surface;
an outer surface;
a plurality of ridges;
the planar base comprises a lateral edge;
the lateral wall comprises a proximal edge and a distal edge;
the lateral edge comprises a small curve and a large curve;
the small curve and the large curve being positioned opposite each other along the planar base;
the lateral wall being positioned around the planar base;
the proximal edge being perimetrically positioned around the lateral wall;
the distal edge being perimetrically positioned around the lateral wall opposite the proximal edge;
the proximal edge being perimetrically connected to the lateral edge;
the inner surface being positioned about both the planar base and the lateral wall;
the outer surface being positioned about both the planar base and the lateral wall opposite the inner surface;
the plurality of ridges being integrated into the lateral wall;
each of the plurality of ridges being positioned from the distal edge to the proximal edge;
the plurality of ridges being interspersed around the lateral wall;
the lateral wall being tapered from the distal edge to the proximal edge;
the inner surface being concavely positioned about the planar base and the lateral wall; and
the outer surface being convexly positioned about the planar base and the lateral wall.

17. The shaped cooking vessel as claimed in claim 16 comprises:
the inner surface defining a cooking vessel receiving contour for a subsequent cooking vessel.

18. The shaped cooking vessel as claimed in claim 16 comprises:
the outer surface defining a cooking vessel insertion contour for a preceding cooking vessel.

19. The shaped cooking vessel as claimed in claim 16 comprises:
the inner surface being polytetrafluoroethylene.

20. The shaped cooking vessel as claimed in claim 16 comprises:
the planar base and the lateral wall being stainless steel.
